(19) United States
(12) Patent Application Publication
(10) Pub. No.: US 2008/0166510 A1
(43) Pub. Date: Jul. 10, 2008

(54) CYCLE FRAME TUBE

(76) Inventor: Pei-Chuan MA, Taipei City (TW)

Correspondence Address: LEONG C LEI, PMB # 1008, 1867 YGNACIO VALLEY ROAD, WALNUT CREEK, CA, 94598, US

(21) Appl. No.: 11/621,578

(22) Filed: Jan. 10, 2007

(51) Int. Cl. B32B 1/08

(52) U.S. Cl. 428/36.1

(57) ABSTRACT

A novel frame tube is provided herein, which mainly contains a number of coaxial tubular layers. The innermost one or two layers of the frame tube are made of a fiber material, and the outmost layer is a metallic net (preferably formed by diagonally weaved steel wires). Epoxy resin is interposed between the adjacent layers as an adhesive.

### TECHNICAL FIELD OF THE INVENTION

The present invention generally relates to the frame tubes of bicycle or tricycles, and more particularly to a frame tube formed by tubular fiber and metallic nets.

### DESCRIPTION OF THE PRIOR ART

As shown in FIG. 1, a conventional bicycle frame consists of a number of frame tubes 2 integrally molded by a single type of material such as iron, alloy, or carbon fiber. As one type of material is used for the bicycle frame tubes, it is usually difficult to achieve the desired strength from the bicycle frame for a modest production cost.

### SUMMARY OF THE INVENTION

The primary purpose of the present invention is to provide a novel frame tube for a bicycle or the like (hereinafter, the cycle), which mainly contains a number of coaxial tubular layers. The innermost one or two layers of the frame tube are made of a fiber material, and the outmost layer is a metallic net (preferably formed by diagonally weaved steel wires). Epoxy resin is interposed between the adjacent layers as an adhesive.

The advantage of the novel frame tube lies in that more than one type of material is adopted to form the frame tube so that, as the features of these materials are integrated together and compensate each other, superior frame strength and reduced production cost can be achieved simultaneously.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective schematic diagram showing a conventional frame tube.

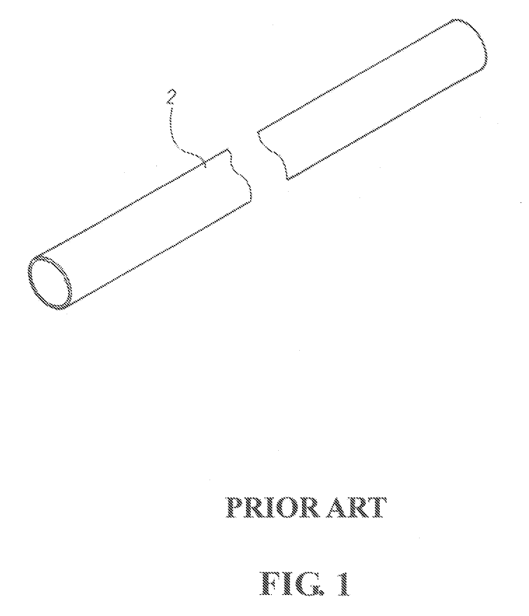

FIG. 2 is a perspective exploded diagram showing the various components of a frame tube according to an embodiment of the present invention.

FIG. 3 is a schematic diagram showing the adhesion of the various components of FIG. 2.

FIG. 4 is a perspective diagram showing the frame tube of FIG. 2 after it is completed.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

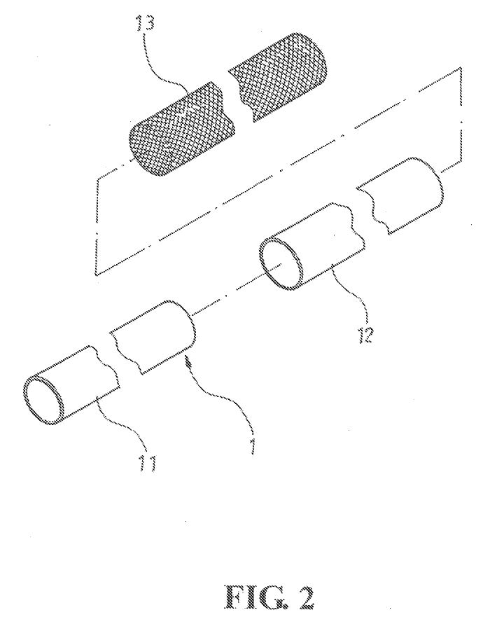

As shown in FIG. 2, the frame tube according to the present invention mainly contains a number of coaxial tubular layers. The innermost one or two layers of the frame tube are made of a fiber material, and the outmost layer is a metallic net (preferably formed by diagonally weaved steel wires).

In the present embodiment, the innermost layer 11 of the frame tube 1 is made of glass fiber, the outmost layer 13 is a metallic net (preferably formed by diagonally weaved steel wires), and the intermediate layer 12 sandwiched therebetween is made of carbon fiber.

In some embodiments, only a single inner layer will suffice. For example, from the inside out, there is the glass-fiber layer and then the metallic-net layer cladding over the glass-fiber layer.

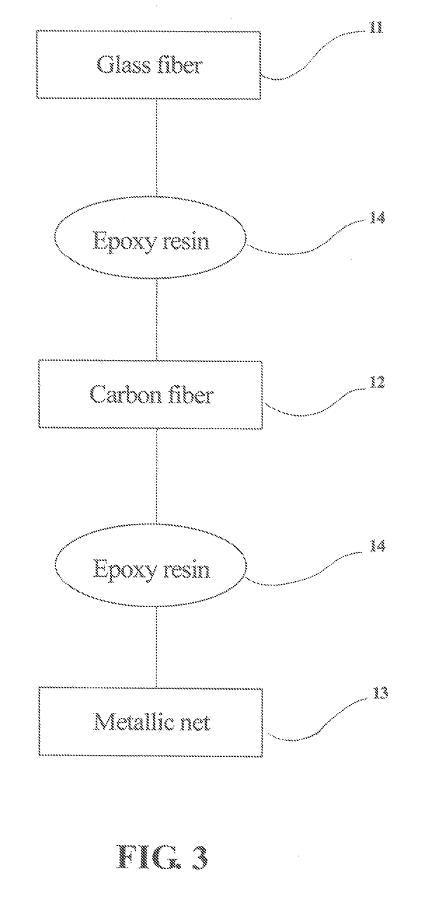

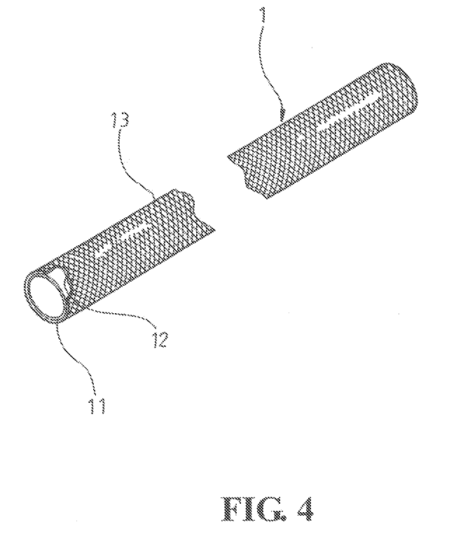

As shown in FIG. 3, to bind the coaxial tubular layers tightly together and so as to enhance the strength of the bicycle frame, epoxy resin 14 is used as adhesive and is interposed between adjacent layers. The completed frame tube 1 is shown in FIG. 4.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A frame tube for a cycle comprising a plurality of coaxial tubular layers wherein the outmost layer is a metallic net; one or more inner layers are made of fiber materials; and epoxy resin is interposed between adjacent tubular layers as an adhesive.

2. The frame according to claim 1, wherein the fiber material is one of the glass fiber and the carbon fiber.

3. The frame tube according to claim 1, wherein the metallic net is formed by diagonally weaved steel wires.

4. The frame tube according to claim 1, wherein the frame tube has a single inner layer of glass fiber.

5. The frame tube according to claim 1, wherein the frame tube has two inner layers with an innermost layer of glass fiber and an outer layer of carbon fiber.
